(19) United States
(12) Patent Application Publication
(10) Pub. No.: US 2024/0077181 A1
(43) Pub. Date: Mar. 7, 2024

(54) ELEVATED LIGHTING DEVICE AND STORAGE SYSTEM

(71) Applicant: MILWAUKEE ELECTRIC TOOL CORPORATION, Brookfield, WI (US)

(72) Inventors: Sullivan Dee, West Allis, WI (US); Jason Isaacs, Milwaukee, WI (US)

(21) Appl. No.: 18/461,567

(22) Filed: Sep. 6, 2023

Related U.S. Application Data
(60) Provisional application No. 63/403,939, filed on Sep. 6, 2022.

(51) Int. Cl. F21L 4/04; F21V 21/06; F21V 33/00

(52) U.S. Cl. CPC F21L 4/04; F21V 21/06; F21V 33/0084; F21W 2131/1005

(57) ABSTRACT

A portable lighting system includes a base having a housing and a cover coupled to the housing. The cover includes an opening. The housing defines a cavity. The cover moves between a closed position, in which the cavity is enclosed by the cover, and an open position, in which the cavity is accessible. The portable lighting system further includes a mast extending between a first end and a second end, the first end configured to removably couple to the housing through the opening in the cover. A light head is coupled to the second end of the mast. The portable lighting system is adjustable between an operating configuration, in which the cover is in the closed position, the first end of the mast is coupled to the housing, and the mast extends through the opening in the cover, and a storage configuration, in which the mast and the light head are received within the cavity.

### CROSS REFERENCE TO RELATED APPLICATION(S)

This application claims priority to co-pending U.S. Provisional Patent Application No. 63/403,939, filed Sep. 6, 2022, the entire contents of which are incorporated by reference herein.

### SUMMARY

The present disclosure relates to transportation and storage of elevated lighting devices. The present disclosure is directed generally to the field of tool storage systems and related devices. The present disclosure relates specifically to a device or unit that includes one or more light-emitting components, and a coupling mechanism to detachably couple the device to another such device or container, such as a tool storage container in a modular tool storage system.

Tool storage units are often used to transport tools and tool accessories. Some storage units are designed to incorporate into a modular storage system. Within a modular storage system, different units, devices and/or containers may provide varying functions, such as being adapted to provide light.

The present disclosure provides, in one aspect, a portable lighting system includes a base having a housing and a cover coupled to the housing. The cover includes an opening. The housing defines a cavity. The cover moves between a closed position, in which the cavity is enclosed by the cover, and an open position, in which the cavity is accessible. The portable lighting system further includes a mast extending between a first end and a second end, the first end configured to removably couple to the housing through the opening in the cover. A light head is coupled to the second end of the mast. The portable lighting system is adjustable between an operating configuration, in which the cover is in the closed position, the first end of the mast is coupled to the housing, and the mast extends through the opening in the cover, and a storage configuration, in which the mast and the light head are received within the cavity.

The present disclosure provides, in another aspect, a stackable case configured to couple to a stackable storage unit, the stackable case including a housing, a cavity defined by the housing, and a cover movably coupled to the housing to selectively enclose the cavity. The cover includes an opening. The cavity is configured to receive a mast and an accessory device. A support member is configured to support the mast in a generally upright position in which the mast extends through the opening in the cover and couples to the accessory device to support the accessory device outside the cavity. The case further includes a plurality of coupling components that couple the housing to the stackable storage unit.

The present disclosure provides, in another aspect, a method of operating a lighting device, the method including providing a base including a housing defining a cavity, and a cover having an opening. The cover is moved to an open position that allows access to the cavity. A mast and a light head are removed from the cavity. The cover is moved to a closed position that encloses the cavity. A first end of the mast is positioned inside the cavity through the opening in the cover. The first end of the mast is secured to the housing. The light head is coupled to a second end of the mast.

Other features and aspects of the disclosure will become apparent by consideration of the following detailed description and accompanying drawings.

### BRIEF DESCRIPTION OF THE FIGURES

FIG. 1 illustrates a lighting device in an in-use configuration, the lighting device including a mast, a base having a cover, and a light head in a first position.

FIG. 2 illustrates the lighting device of FIG. 1 with the light head in a second position.

FIG. 3 illustrates the lighting device of FIG. 1 in a storage configuration.

FIG. 4 illustrates a user interface of the lighting device of FIG. 1.

FIG. 5 illustrates a battery receptacle of the lighting device of FIG. 1.

FIG. 6 illustrates the lighting device of FIG. 1 in the storage configuration with the cover in an open configuration, providing access to a cavity of the base.

FIG. 7 illustrates the lighting device of FIG. 1 with a support member extending in the cavity.

FIG. 8 illustrates the mast and light head of FIG. 1 in a disassembled configuration.

FIG. 9 illustrates interfaces of the lighting device of FIG. 1 for connecting the mast to the light head.

FIG. 10 is an end view of the interface of the mast of FIG. 9.

FIG. 11 illustrates a wiring connection extending through an opening in the base of FIG. 1.

FIG. 12 illustrates an exemplary connector for use with the lighting device of FIG. 1.

FIG. 13 illustrates exemplary accessory heads for use with the lighting device of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

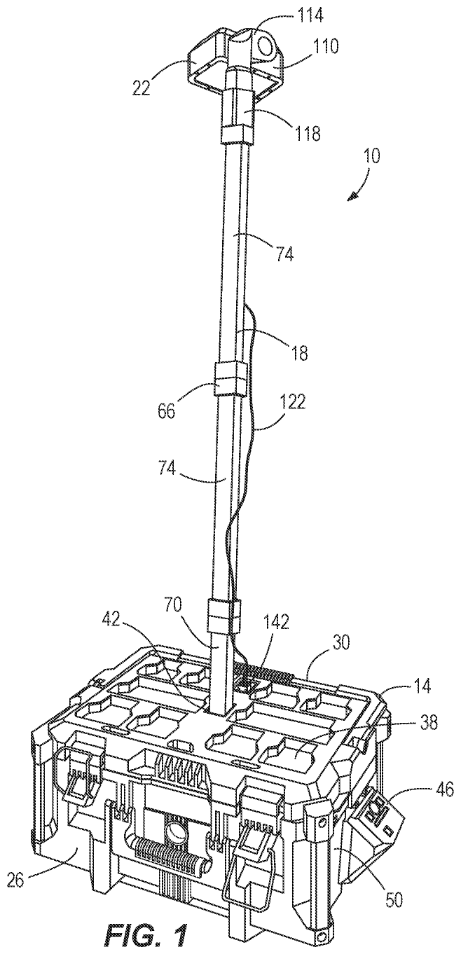

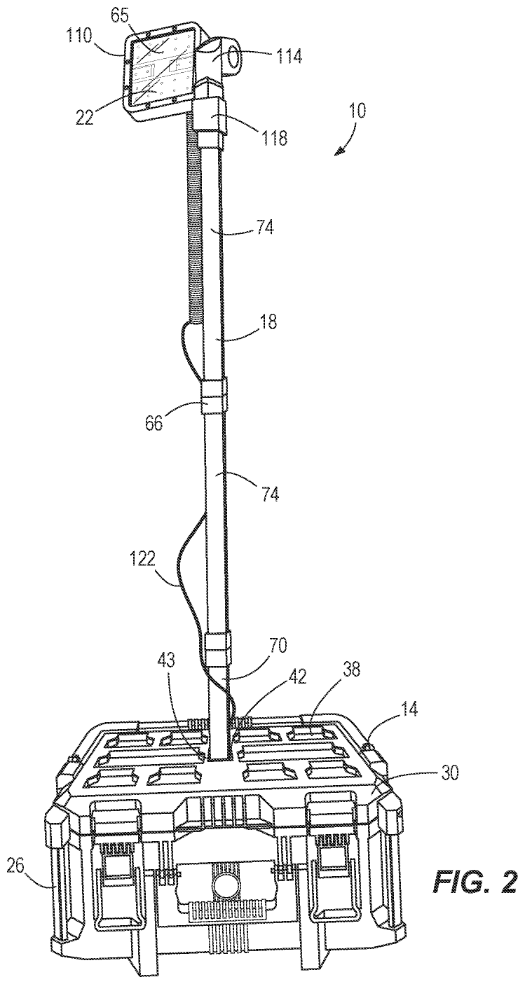

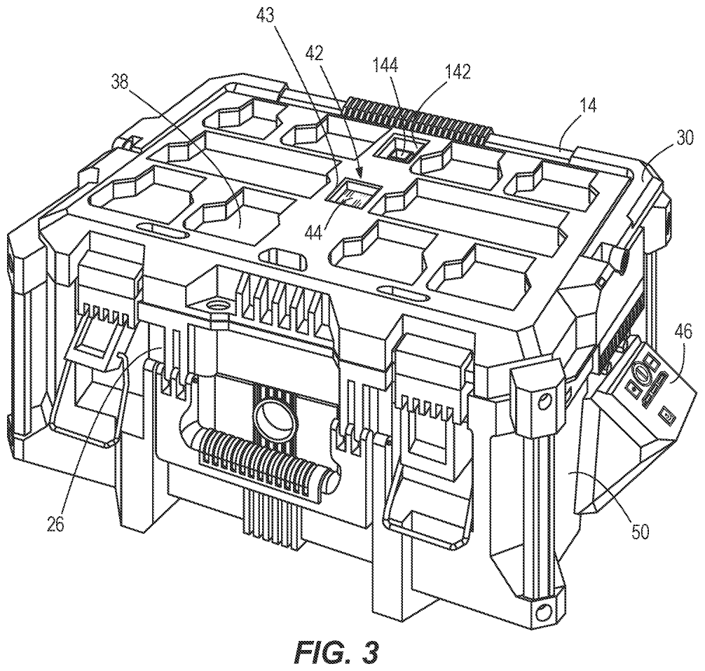

FIGS. 1 and 2 illustrate a stackable device 10 having a base 14, a mast 18 extending from the base 14, and an accessory device 22 (also referred to herein as an accessory head 22) coupled to the mast 18. In the illustrated embodiment, the stackable device 10 is depicted as a lighting device 10 (also referred to herein as a portable lighting system) and the accessory head 22 is a light head 22. The light head 22 includes one or more lighting elements 65, such as LEDs, light bulbs, or the like, to provide light to an area. The lighting device 10 is adjustable between an in-use configuration or operating configuration (shown in FIGS. 1-2) and a storage configuration (shown in FIG. 3). In the in-use configuration, the mast 18 extends from the base 14 and the light head 22 is coupled to the mast 18 to provide illumination to an area. In the storage configuration, the mast 18 and light head 22 are received within the base 14. In particular, the mast 18 and the light head 22 are fully received within the base 14.

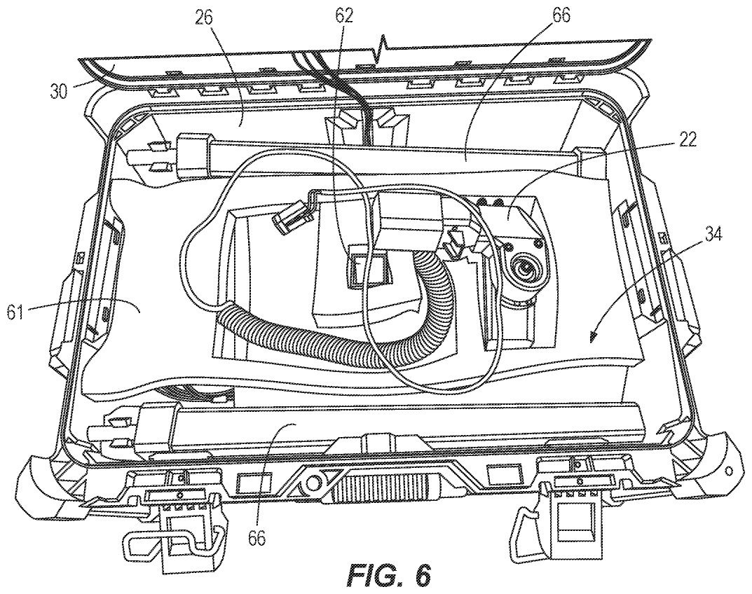

With reference to FIG. 3, the base 14 is illustrated as a stackable case or storage unit and includes a housing 26 defining a cavity 34 (FIG. 6) and a cover 30. In some embodiments, the cover 30 is movably (e.g., pivotally, removably, etc.) coupled to the housing 26 for movement between a closed configuration, in which the cover 30 is coupled to the housing 26 and encloses the cavity 34, and an open configuration (FIG. 6), in which the cavity 34 is accessible. The stackable device 10 illustrated in FIGS. 1-13 may be coupled to another stackable device (not shown), such as a stackable storage unit, to create a modular storage system. For example, the device 10 may be part of a stackable storage system, such as Milwaukee Tool's PACKOUT modular storage system. The base 14 may include a first set of coupling components positioned on a first or bottom surface of the housing 26. The first set of coupling components interface with corresponding coupling components on a top surface of the other stackable device to couple the device 10 to the other stackable device. The base 14 may include a second set of coupling components 38 on a second or top surface of the cover 30 which interface with corresponding coupling components on a bottom surface of the other stackable device to couple the device 10 to the other stackable device. The first set of coupling components on the housing 26 have a complementary configuration to the coupling components 38 on the cover 30. For example, the first set of coupling components may be cleats, and the second set of coupling components 38 may be recesses that are sized and shaped to receive the cleats. In other embodiments, the first set of coupling components may be recesses and the second set of coupling components 38 may be cleats, or both the first and second sets of coupling components may include a mixture of cleats and recesses.

With continued reference to FIG. 3, the base 14 includes an opening 42 formed in the cover 30. As seen in FIGS. 1 and 2, when the device 10 is in the in-use configuration the opening 42 surrounds a portion of the mast 18 to support the mast 18 in a generally upright position. In some embodiments, the opening 42 or the mast 18 may include a seal 43 that fills any gap between the mast 18 and the opening 42 to isolate the cavity 34 from the external environment when the lighting device 10 is in the in-use configuration. The seal 43 inhibits dirt, water, and other external contaminants from entering the cavity 34 through the opening 42. In the illustrated embodiment, the opening 42 is centered on the cover 30, however, in other embodiments the opening 42 may be positioned at other locations on the cover 30. In some embodiments, the opening 42 is selectively coverable by a stopper 44 (e.g., a door, a plug, a cover, or other suitable closure). Thus, when the device 10 is in the storage configuration with the cover 30 closed and the mast 18 removed, the opening 42 may be closed (e.g., filled or covered) by the stopper 44 and the cavity 34 of the base 14 may be isolated from the external environment.

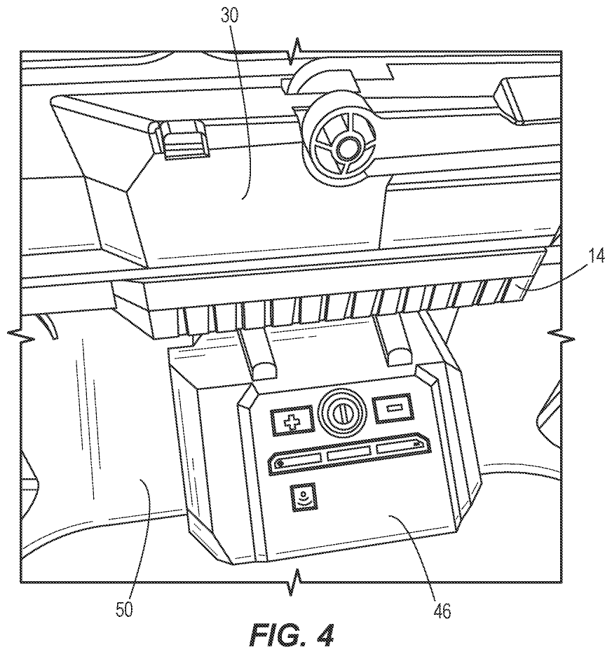

As shown in FIG. 4, the base 14 includes a user interface 46. In the illustrated embodiment, the user interface 46 is positioned adjacent a first sidewall 50 of the housing 26. In other embodiments, the user interface 46 may be positioned in other places, including inside the cavity 34, on the cover 30, or on the mast 18 or light head 22. In some embodiments, the base 14 may include a wireless transceiver to wirelessly communicate commands and data between the device 10 and a remote device (e.g., a user's smartphone, tablet, laptop, computer, etc.). For example, the user interface 46 may also be integrated with a tool management system using Bluetooth® enabled tags, such as Milwaukee Tool's ONEKEY system. The user interface 46 includes various controls (e.g., buttons, switches, displays, indicators, etc.) to allow an operator to control operation of the device 10 and the accessory head 22. In the illustrated embodiment, the illumination of the light head 22 may be controlled by the user interface 46. For example, the user interface 46 may include a power button or ON/OFF switch to selectively provide power to the lighting elements 65 in the light head 22. The user interface 46 may also include buttons or switches to adjust the intensity and/or mode of the light emitted from the light head 22 (e.g., low, medium, high, flashing, strobe, etc.). The user interface 46 may also include a battery gauge to display the amount of charge remaining in a connected battery.

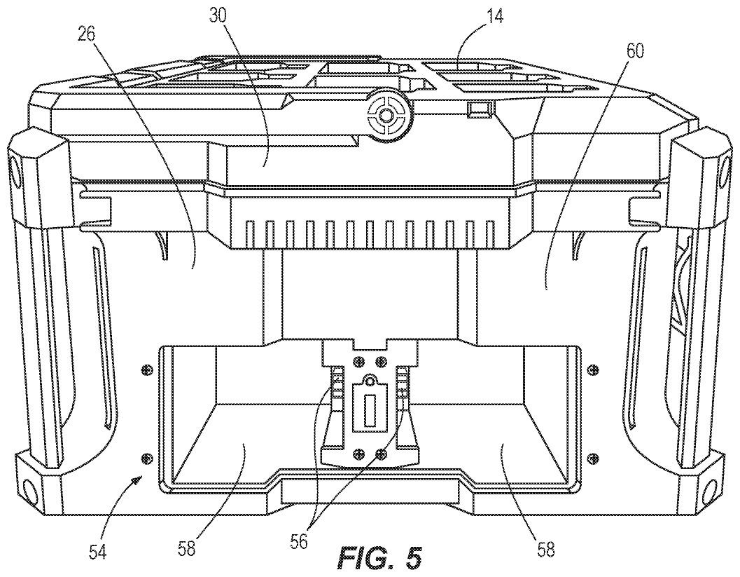

Turning to FIG. 5, the base 14 includes a battery interface 54 for removably receiving at least one battery. In the illustrated embodiment, the battery interface 54 includes two battery receptacles 58 positioned on a second sidewall 60 of the housing 26, opposite the first sidewall 50. In other embodiments, the battery interface 54 may be positioned in other places (e.g., inside the cavity 34, on the cover 30, on the mast 18 or light head 22, etc.). The battery receptacles 58 include electrical contacts 56 so that the batteries coupled to the battery interface 54 may connect to an internal wiring system or electronic circuit of the base 14, that may connect to the light head 22. The battery interface 54 may include more or fewer battery receptacles 58, such as one battery receptacle or three or more battery receptacles. The batteries may be removable and rechargeable batteries, for example, 18V power tool battery packs. In other embodiments, the battery packs may have other voltages, such as 9V, 12V, 40V, and the like. In other embodiments, the base 14 may additionally or alternatively include an integrated battery. The rechargeable batteries coupled to the battery interface 54 may be charged by the integrated battery or may provide charge to the integrated battery. The battery interface 54 may include an AC interface in addition to or in alternative to the battery receptacles 58. The AC interface may connect the internal power circuit to power through a cable connected to, for example, a wall outlet or generator. In some embodiments, the AC interface may be used to recharge the integrated battery, or the rechargeable batteries connected to the battery interface 54 via a charging circuit in the base 14. In other embodiments, the AC interface may connect another device to the base 14 to power the other device using the connected batteries.

As seen in FIG. 6, the cover 30 may be moved to an open configuration to allow access to the cavity 34. In the illustrated embodiment, the cover 30 is pivotable about a hinge coupled to the housing 26. In other embodiments, the cover 30 may be removable and separable from the housing 26. The mast 18 and the light head 22 may be stored inside the cavity 34 of the base 14 for easy transport of the lighting system. In the storage configuration, the mast 18 and the light head 22 are fully received inside the cavity 34. When the cover 30 is in the closed configuration, the mast 18 and the light head 22 are enclosed within the cavity 34. In some embodiments, the cavity 34 includes an internal support structure 61 including structured recesses shaped to receive the different pieces. The support structure 61 may be formed from, for example, foam or other soft material to protect the pieces during transport. In some embodiments, the support structure 61 may include clamps or clips to couple the pieces to the housing 26 to inhibit movement of the pieces during transport. In the illustrated embodiment, the cavity 34 also contains the wiring and electrical components of the internal power circuit that couple the battery to the user interface 46 and the light head 22. In other embodiments, the wiring of the internal power circuit of the base 14 is built into the housing 26 and is not accessible through the cavity 34. In some embodiments, and as will be discussed in more detail below, the cavity 34 may also store additional pieces that may be swappable with the illustrated components to create a modular and adaptable system.

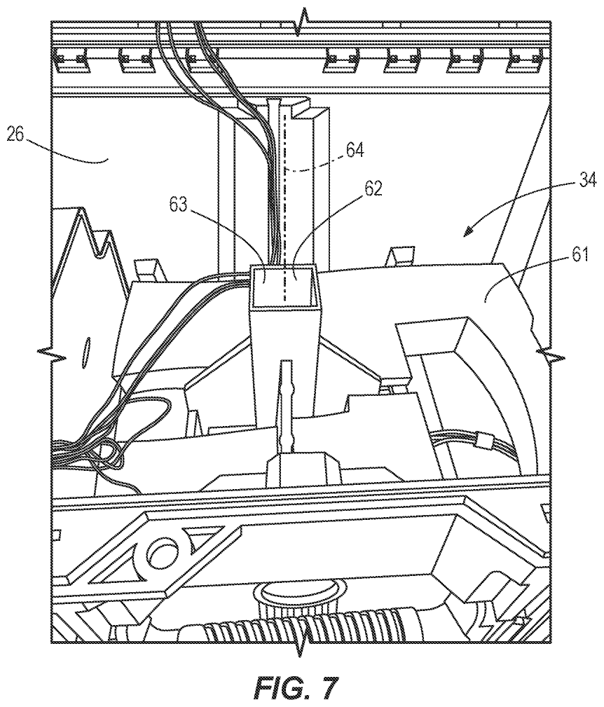

With reference to FIG. 7, the cavity 34 also contains a support member 62. In some embodiments, the support member 62 is permanently fixed to the housing 26 (e.g., integrally formed, securely fastened, etc.). When the device 10 is in the storage configuration, the poles 66 of the mast 18 are separated or spaced from the support member 62 and are not coupled to the support member 62 (FIG. 6). In other embodiments, the support member 62 is movable within or removable from the cavity 34. The illustrated support member 62 is a square tube, but may alternatively take other forms (e.g., circular, hexagonal, oblong, etc.). In the illustrated embodiment, the support member 62 includes a channel 63 that extends along a channel axis 64. In the in-use configuration, the support member 62 is positioned in the cavity 34 to be directly beneath the opening 42 of the cover 30 such that the channel axis 64 passes through the opening 42. In other words, when the cover 30 is in the closed configuration, the support member 62 is aligned with the opening 42 in the cover 30.

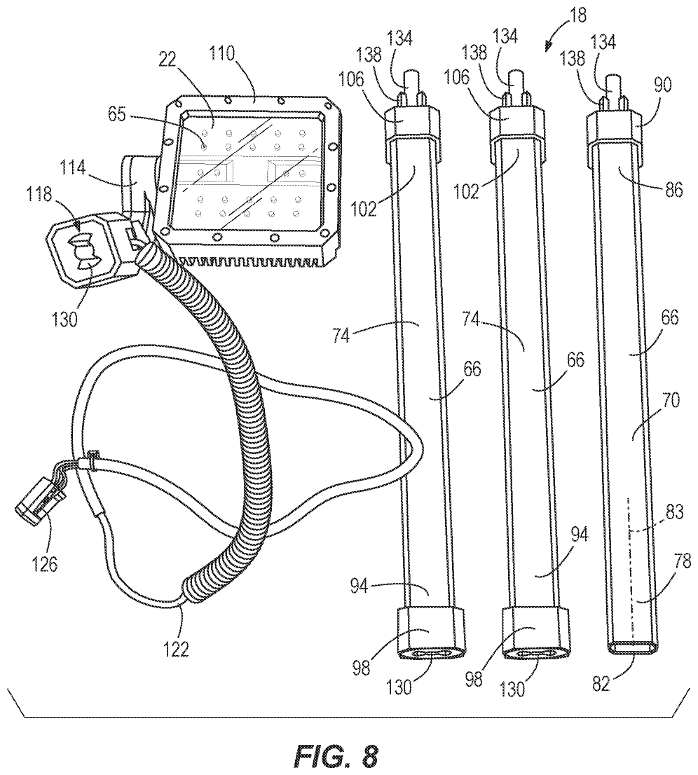

With reference to FIGS. 6 and 8, in the illustrated embodiment, the mast 18 includes a plurality of poles 66 that are removably coupled to each other. In other embodiments, the mast 18 may include a single pole, or may include a set of telescoping rods. In the illustrated embodiment, the mast 18 is formed from a base pole 70 and two extension poles 74. The two extension poles 74 may be selected from a set of extension poles 74 contained in the cavity 34. In some embodiments, additional extension poles 74 can be added to customize the height. In some embodiments, the extension poles 74 may be of varying lengths to allow for greater customization. The extension poles 74 may be selected to create a mast 18 with a height between 50 and 100 inches. In the illustrated embodiment, a height of the mast 18 may be approximately 61 inches. In other embodiments, the height of the mast 18 may be approximately 84 inches. In some embodiments, all the extension poles 74 are used to form the mast 18. In other embodiments, some extension poles 74 remain in the cavity 34 during operation of the lighting device 10.

With continued reference to FIG. 8, the base pole 70 extends along a pole axis 83 between a first end 78 and a second end 86. The first end 78 includes a base connector 82 for coupling to the support member 62. In the illustrated embodiment, the base connector 82 includes a straight portion extending along the pole axis 83. The base connector 82 may be received in the channel 63 of the support member 62 so that the pole axis 83 aligns with the channel axis 64. In some embodiments, the connection may be reversed and the base pole 70 may include the channel 63 and the support member 62 may be received by the channel 63. In further embodiments, the base pole 70 may be coupled to the support member 62 in a different way. For example, the base pole 70 may include a collar (e.g., a threaded collar) to help secure the base pole 70 to the support member 62. The second end 86 of the base pole 70 includes a pole connector 90 for connecting to one of the extension poles 74. In the illustrated embodiment, the pole connector 90 has an interface of a first type.

Each extension pole 74 extends between a first end 94 having a first connector 98 and a second end 102 having a second connector 106. In the illustrated embodiment, the first connector 98 has an interface of a second type. The second connector 106 has an interface of the first type. Thus, the interface of the second connector 106 is generally the same as the interface of the pole connector 90 of the base pole 70. The first interface type and the second interface type have a complementary configuration so that the first connector 98 of an extension pole 74 can couple to the second connector 106 of another extension pole 74 or to the pole connector 90 of the base pole 70. The pole connector 90 being the same interface as the second connector 106 allows any extension pole 74 to couple to the base pole 70 and allows as many extension poles 74 as needed to be coupled together, increasing the modularity of the system. The connectors 90, 98, 106 couple the plurality of poles 66 together to form the mast 18.

With continued reference to FIG. 8, the light head 22 includes a main body 110 containing the lighting elements 65. The main body 110 is pivotably coupled to a support post 114 and the support post 114 is rotatably coupled to a light connector 118 to allow for easy and precise adjustment of the illumination direction of the light head 22. The light connector 118 connects the light head 22 to the mast 18 and includes an interface of the second type. Thus, the interface of the light connector 118 is generally the same as the interface of the first connector 98 of the extension poles 74 and is complementary to the second connector 106 of the extension poles 74 and the pole connector 90 of the base pole 70. Therefore, any extension pole 74 or the base pole 70 may couple to the light head 22, increasing the modularity of the system.

In the illustrated embodiment, the light head 22 includes a wire 122 extending from the light head 22 and that is electrically connected to the lighting elements 65. The illustrated wire 122 is an external wire that is located outside of the mast 18, when assembled. In other embodiments, the wire 122 may be routed through the mast 18. The wire 122 may include a plug 126 positioned at the end opposite the light head 22 that couples to a power source (for example, via the internal power circuit of the base 14). In other embodiments, the mast 18 and the light head 22 may include integrated wiring and the connectors 82, 90, 98, 106 may include electrical contacts that transfer power from the base 14 to the light head 22.

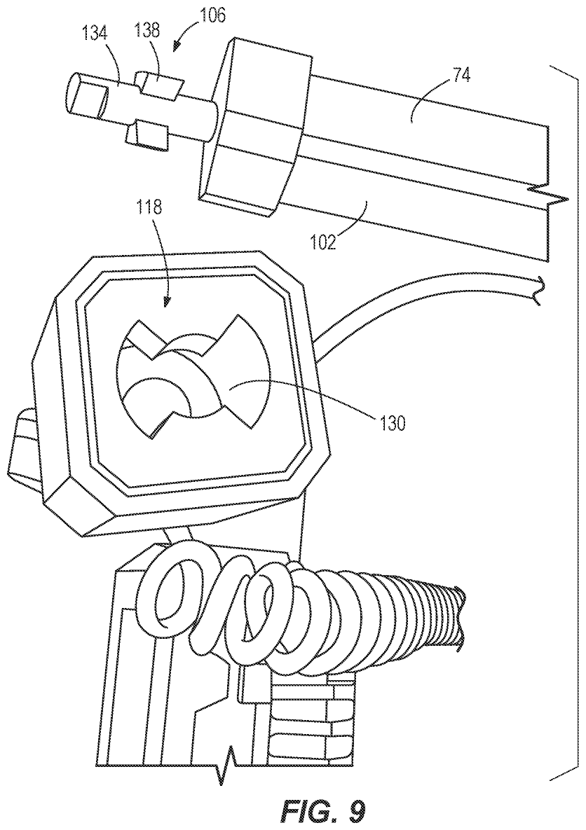

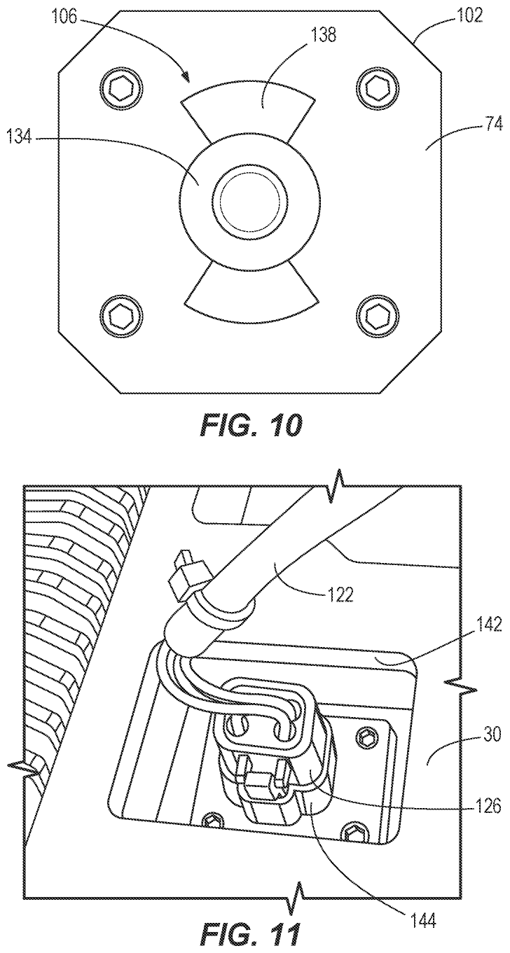

FIGS. 9 and 10 illustrate the first and second types of interfaces in the context of the light connector 118 of the light head 22 and the second connector 106 of the extension pole 74. The first type of interface, as seen on the second connector 106, includes a first protrusion 134 and a second protrusion 138. The first protrusion 134 (also referred to herein as the shaft 134) extends to a first height. The end of the shaft 134 may be non-circular. The second protrusion 138 (also referred to herein as the key 138) is positioned on the shaft 134 at a second height, lower than the first height.

The second type of interface, as seen on the light connector 118, includes a shaped opening 130. In some embodiments, a retaining mechanism may be positioned within the shaped opening 130 and may be configured to engage the shaft 134. The shaped opening 130 has a complementary shape to the key 138 such that the key 138 can be received within the shaped opening 130. In the illustrated embodiments, the shaped opening 130 and the key 138 each have corresponding “bowtie” profiles, however, in other embodiments other key shapes may be used. The profiles of the interfaces allow the second connector 106 to be inserted into the first connector 118 and rotated (e.g., a quarter turn or 90 degrees), creating a bayonet-style coupling. While described in reference to the light connector 118 and the second connector 106, the description of the first and second types of interfaces also apply to the other connectors. Additionally, while specific configurations of the interfaces and connections are described herein, the connections between the light head 22, the extension poles 74, and the base pole 70 may be accomplished using coupling means other than a keyed connection. For example, the connections may be achieved using a snap fit, a threaded coupling, a clamp, or the like. In each embodiment, the first interface is complementary to the second interface, such that connectors with the first interface may be coupled to the connectors with the second interface, increasing the modularity of the system.

FIG. 11 illustrates a wire opening 142 in the cover 30. In the illustrated embodiment, the wire opening 142 allows access to a port 144 electrically connected to the internal wiring system of the base 14. The plug 126 of the wire 122 of the light head 22 may be coupled to the port 144 to connect the light head 22 to the internal power circuit, the user interface 46, and the connected batteries. In the illustrated embodiment, the wire opening 142 is positioned in the cover 30 adjacent the hinge. In other embodiments, the wire opening 142 may be positioned elsewhere on the cover 30 or the rest of the base 14. In still other embodiments, the wire opening 142 may be combined with the opening 42 as a single opening. In some embodiments, the wire opening 142 includes a stopper and/or seal to isolate the cavity 34 from the external environment, similar to the stopper 44 and seal 43 described with reference to the opening 42.

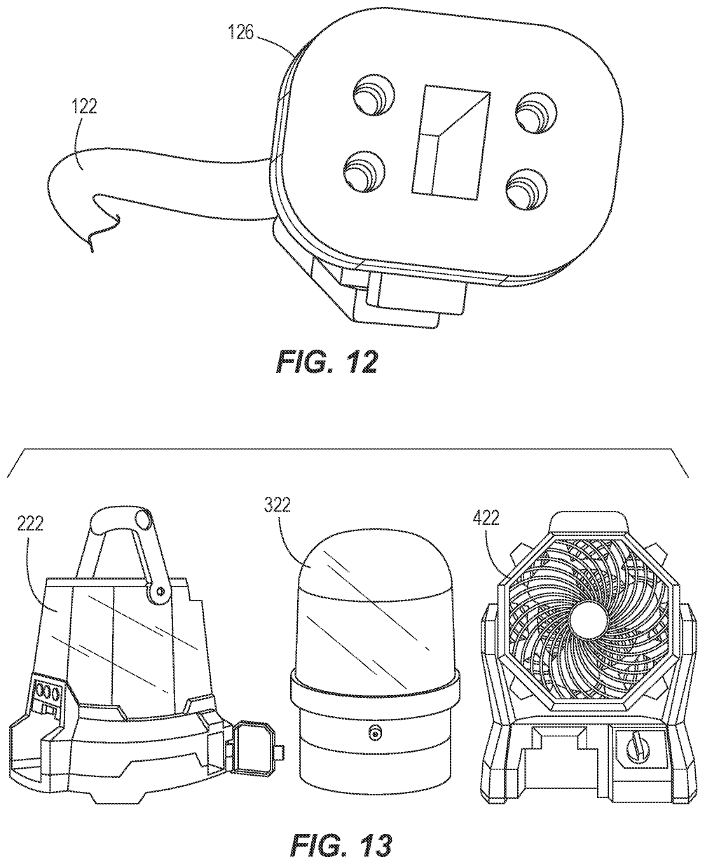

FIG. 12 illustrates an exemplary interface of the plug 126 for connecting to the port 144 and the electronics of the base 14. In other embodiments, the plug 126 may include a different interface, for example, a USB, USB-C, or other power interface. As mentioned above, in some embodiments, the electronic connection between the light head 22 and the base 14 may be run through the mast 18. In those embodiments, the wire 122, the plug 126, the wire opening 142, and the port 144 may be omitted.

To operate the portable lighting system, the lighting device 10 may be transported, in the storage configuration, to a worksite or other area. The base 14 is placed on a surface and the light is moved to the in-use configuration. First, the cover 30 is moved to the open configuration, allowing access to the cavity 34. For example, the cover 30 may pivot about the hinges away from the cavity 34. The mast 18 and the light head 22, fully received in the cavity 34, are removed from the cavity 34 of the base 14. Specifically, the desired poles 66 (e.g., the base pole 70 and two extension poles 74) and the desired accessory head (e.g., the light head 22) are removed from the cavity 34. If not already in place, the support member 62 is secured to the housing 26 in the correct position within the cavity 34, with the axis 64 of the channel 63 extending generally vertically.

After the pieces are removed from the cavity 34, the cover 30 is then moved to the closed configuration, for example by pivoting the cover 30 about the hinges toward the cavity 34. In the closed configuration, the cover 30 encloses the cavity 34 and the cavity 34 is no longer accessible. The pieces not selected and removed may remain fully received by and enclosed in the cavity 34. With the cover 30 in the closed configuration, the opening 42 is aligned with the support member 62. In other words, the channel axis 64 defined by the channel 63 of the support member 62 extends through the opening 42 of the cover 30.

To assemble the mast 18 to the base 14, the first end 78 of the base pole 70 is moved through the opening 42 into the cavity 34. The base connector 82 slides into the channel 63 to couple the base pole 70 to the housing 26. The base pole 70 is received in the opening 42 of the cover 30, and the opening 42 and the support member 62 cooperate to support the base pole 70 in a generally upright position, with the base pole 70 coaxial with the channel axis 64. The contact between the cover 30 and the base pole 70 adds additional stability to the mast 18 compared to the support member 62 alone. If included, the seal 43 fills any gap between the opening 42 and the base pole 70 and inhibits ingress of water and contaminants through the opening 42. In some embodiments the base pole 70 may include a retaining mechanism with a release actuator to securely couple the base pole 70 to the support member 62. The release actuator may be positioned adjacent the second end 86 of the base pole 70, outside the cavity 34 and is accessible when the cover 30 is closed.

One of the extension poles 74 is coupled to the base pole 70. Specifically, the pole connector 90 is coupled to the first connector 98 of the extension pole 74 via the complementary interfaces. In the illustrated embodiment, the shaft 134 and key 138 are aligned with and inserted into the shaped opening 130. Once the key 138 has been inserted a certain depth, the poles 66 can be rotated with respect to each other until the key 138 no longer aligns with the shaped opening 130, inhibiting the extension pole 74 from sliding away from the base pole 70. In some embodiments, the connection may include alternate or additional retaining mechanisms to secure the poles 66 together. Further extensions poles 74 can be coupled to the attached extension pole 74 as desired by coupling the first connector 98 with the second connector 106 in the same manner described above. In the illustrated embodiment the connections align the extension poles 74 with the base pole 70 so the extension poles 74 are also coaxial with the channel axis 64. The light head 22 is then coupled to the uppermost extension pole 74 by coupling the light connector 118 to the second connector 106 of the uppermost extension pole 74 in the same manner described above.

The light head 22 is electrically coupled to the base 14 by extending the wire 122 and connecting the plug 126 to the port 144 of the base 14 through the wire opening 142. If present, the seal 43 inhibits water and other contaminants from accessing the cavity 34 through the wire opening 142. One or more batteries are connected to the battery receptacles 58 of the battery interface 54 to provide power to the internal power circuit. The lighting device 10 can then be operated using the user interface 46. For example, the operator can use the power button on the user interface 46 to provide power to the lighting elements 65 and to control an illumination output of the light head 22.

While portions of the assembly process or method are discussed in a certain order, this order is not intended to be limiting and steps of the method may be moved around or repeated as needed by the operator. In some embodiments, the base pole 70 is coupled to the base 14, then the extension pole(s) 74 are coupled to the base pole 70 to form the mast 18, and then the light head 22 is coupled to the mast 18. In other embodiments, the connections may occur in different orders. For example, the extension pole(s) 74 may be coupled to the base pole 70 before the base pole 70 is coupled to the base 14. Or the light head 22 may be coupled to the extension pole 74 before the extension pole 74 is coupled to the adjacent pole 66. The batteries may be coupled to the base 14 before or after the mast 18 is coupled to the base 14 and may remain coupled to the base 14 when the device 10 is in the storage configuration. The disclosed method includes these and other variations.

As seen in FIG. 13, in some embodiments, the device 10 may include multiple accessory devices. For example, the light head may include a flood light 22 (FIG. 1), an area light 222, or a hazard light 322. The device 10 may also include a fan head 422. The device 10 may include still other types of accessory devices such as cameras, spot lights, sensors, radios, etc. These heads 22, 222, 322, 422 may be coupled to the mast 18 interchangeably and may be stored in the cavity 34. The accessory heads not currently in use may be stored in the cavity 34 while the lighting device 10 is in the in-use configuration.

Although the disclosure has been described in detail with reference to certain preferred embodiments, variations and modifications exist within the scope and spirit of one or more independent aspects of the disclosure as described.

What is claimed is:

1. A portable lighting system comprising:
a base including a housing and a cover coupled to the housing, the cover including an opening, the housing defining a cavity, the cover configured to move between a closed position, in which the cavity is enclosed by the cover, and an open position, in which the cavity is accessible;
a mast extending between a first end and a second end, the first end configured to removably couple to the housing through the opening in the cover; and
a light head coupled to the second end of the mast;
wherein the portable lighting system is adjustable between:
an operating configuration, in which the cover is in the closed position, the first end of the mast is coupled to the housing, and the mast extends through the opening in the cover, and
a storage configuration, in which the mast and the light head are received within the cavity.

2. The portable lighting system of claim 1, wherein the base further includes a support member positioned in the cavity, and wherein the support member engages the first end of the mast to couple the mast to the housing in the operating configuration.

3. The portable lighting system of claim 2, wherein the support member is aligned with the opening in the cover when the cover is in the closed position, and wherein, in the operating configuration, the support member and the opening cooperate to support the mast in a generally upright position.

4. The portable lighting system of claim 2, wherein the first end of the mast is spaced from the support member in the storage configuration.

5. The portable lighting system of claim 1, wherein the base includes a battery receptacle for receiving a battery to provide power to the light head.

6. The portable lighting system of claim 5, wherein the light head is electrically coupled to the battery receptacle through the mast.

7. The portable lighting system of claim 1, wherein the base is a stackable case, and wherein the cover includes a top surface comprising coupling components that couple the stackable case to a bottom surface of a stackable storage unit.

8. The portable lighting system of claim 1, wherein a seal is positioned between the mast and the opening in the cover to isolate the cavity from an external environment.

9. The portable lighting system of claim 1, wherein, in the storage configuration, the opening is closed by a stopper.

10. A stackable case configured to couple to a stackable storage unit, the stackable case comprising:
a housing;
a cavity defined by the housing and configured to receive a mast and an accessory device;
a cover movably coupled to the housing to selectively enclose the cavity, the cover including an opening;
a support member configured to support the mast in a generally upright position in which the mast extends through the opening in the cover and couples to the accessory device to support the accessory device outside the cavity; and
a plurality of coupling components that couple the housing to the stackable storage unit.

11. The stackable case of claim 10, wherein the housing includes a bottom surface comprising coupling components that couple the stackable case to a top surface of the stackable storage unit.

12. The stackable case of claim 10, wherein the cover includes coupling components that couple the stackable case to a bottom surface of the stackable storage unit.

13. The stackable case of claim 10, further comprising a battery receptacle configured to receive a battery to provide power to the accessory device.

14. The stackable case of claim 13, wherein the battery receptacle is positioned on a sidewall of the housing and is accessible when the cavity is enclosed by the cover.

15. The stackable case of claim 13, further comprising a user interface connected operable to control the accessory device.

16. The stackable case of claim 15, wherein the user interface is supported on the housing.

17. The stackable case of claim 10, wherein the cover is pivotably coupled to the housing and is movable between an open position and a closed position, wherein in the closed position the cavity is enclosed by the cover and the opening in the cover is aligned with the support member.

18. A method of operating a lighting device, the method comprising:
providing a base including a housing defining a cavity, and a cover having an opening;
moving the cover to an open position that allows access to the cavity;
removing a mast and a light head from the cavity;
moving the cover to a closed position that encloses the cavity;
positioning a first end of the mast inside the cavity through the opening in the cover;
securing the first end of the mast to the housing; and
coupling the light head to a second end of the mast.

19. The method of claim 18, further comprising coupling the base to a stackable storage unit using coupling components positioned on the cover.

20. The method of claim 18, further comprising electrically coupling the light head to a battery receptacle on the base.
